(19) United States
(12) Patent Application Publication
(10) Pub. No.: US 2021/0142246 A1
(43) Pub. Date: May 13, 2021

(54) SCHEDULING SYSTEM AND METHOD

(71) Applicant: CERTUS OPERATIONS LTD., St Julian's (MT)

(72) Inventor: Anders KARLSSON, Hammarö (SE)

(73) Assignee: CERTUS OPERATIONS LTD., St Julian's (MT)

(21) Appl. No.: 16/617,764

(22) PCT Filed: May 31, 2018
(86) PCT No.: PCT/EP2018/064362

§ 371 Date: Nov. 27, 2019

(30) Foreign Application Priority Data
May 31, 2017 (SE) 1750687-4

(51) Int. Cl. G06Q 10/06; G06Q 10/10; G06Q 10/02

(52) U.S. Cl. CPC G06Q 10/06314; G06Q 10/02; G06Q 10/1095

(57) ABSTRACT

The present invention relates to a system for scheduling resources, the system comprising: a scheduling server for controlling reservations by users of a plurality of resources; a control device configured to, when associated with a resource, communicate data regarding the associated resource to the scheduling server; characterised in: the control device being configured to detect presence of a user of an associated resource; and when detecting presence of a user of the associated resource, communicating presence data relating to the detected presence of the user to the scheduling server, the presence data indicating that a reservation of the resource is made use of.

### FIELD OF THE INVENTION

The present invention relates to scheduling systems for scheduling of resources, and, in particular, the present invention relates to scheduling systems in which an electronic display device is utilized for displaying scheduling information regarding a scheduled resource.

### BACKGROUND OF THE INVENTION

Scheduling of resources, the usage of which being shared among plurality of users, such as, e.g., scheduling of meeting (conference) rooms, parking lots, work spaces etc. is often subject to frustration due to misunderstandings and erroneous/conflicting reservations (bookings). Still, resources of this kind oftentimes stay unused even while being reserved. For example, when e.g. a meeting is planned to occur, a reservation of a resource such as a conference room may be made for the meeting. However, if the planned meeting is subsequently cancelled this does not necessarily mean that the reservation is also cancelled. Oftentimes reservations of resources remain even though the reservation in reality will not be utilized. As a result, a resource may have a status indicating that the resource is occupied, while in reality the resource would be free to use.

Scheduling of resources has been subject to development of various scheduling systems (a.k.a. booking systems), and various systems for scheduling resources exist. These systems, at least with regard to systems of the electronic kind, often have in common that reservations (bookings) are performed through the use of a computer, and the reservation of a resource may then be represented, e.g., in the form of a calendar entry in a calendar representing to the particular resource, and which is accessible, and viewable, e.g. from computers of various users of the system.

Scheduling systems may be of a kind where reservations are not displayed at the location of the particular resource being reserved, but only when accessing the scheduling system from a computer. Such systems may give rise to ambiguities as to whether a resource is actually reserved or not, and may also give rise to undesired situations. For example, a person may enter a meeting room that appears to be empty and therefore free for use, only to subsequently find out that the party having reserved the resource is merely arriving late.

It has been found useful to utilize information displays in connection to scheduling systems for presentation of resource usage information where it may be needed the most, i.e. at the premises of the resource being scheduled, such as, for example, at the entrances of meeting rooms. This presentation may be carried out using display devices that are connected to the scheduling system by means of a suitable network so that scheduling information regarding the resource and maintained by a scheduling server can be communicated over the network to be presented by the display device.

The use of display devices in this manner allows scheduling changes of a resource to be reflected by the display device that is used to display reservations of the resource. Consequently, use of display devices of this kind may allow a person looking for an available resource to see on a display of the display device whether the resource is free for use, or is being reserved and therefore not available.

### SUMMARY OF THE INVENTION

It is an object of the present invention to provide a scheduling system that facilitates efficient use of scheduled resources. This object is achieved by a scheduling system according to the characterizing portion of claim 1.

According to the present invention it is provided a system for scheduling resources,
the system comprising:
a scheduling server for controlling reservations by users of a plurality of resources;
a control device configured to, when associated with a resource, communicate data regarding the associated resource to the scheduling server.

The system is characterised in:
the control device being configured to detect presence of a user of an associated resource; and
when detecting presence of a user of the associated resource, communicating presence data relating to the detected presence of the user to the scheduling server, the presence data indicating that a reservation of the resource is made use of.

The resource may consist of a physical resource such as a room, a location or any other physical entity.

The presence data relating to the detected presence of the user may be communicated to the scheduling server by the control device.

The control device may automatically detect presence of a user by detecting signals transmitted by a user device without any user interaction with the user device being required. For example, signals already being transmitted by the user device may used to detect the user device, and/or the user device may e.g. include functionality to communicate with the control device without user interaction.

As was mentioned above, scheduling systems may facilitate use of resources that are shared by a plurality of users. Use of information displays may further facilitate the use of the scheduling system. However, the benefits of a scheduling system may be reduced by users that make reservations for resources that in reality are never used, or that make reservations for longer periods of time than the resources are actually being used.

According to embodiments of the invention, utilisation of resources of a scheduling system may be increased. This is accomplished using a control device that is configured to, when being associated with a resource, communicate data regarding the associated resource to the scheduling server. The control device may be arranged in proximity to the associated resource. For the sake of clarity, according to the present description and claims, a control device arranged in proximity to an associated resource may be arranged outside or within the resource. Hence, with regard to the example of a room, the control device may e.g. be arranged in proximity to but outside the room, or inside the room.

Furthermore, according to embodiments of the invention, the control device is a display device associated with the scheduled resource and being arranged to display scheduling information regarding the associated resource. The control device may, in addition or alternatively, also be a dedicated device having the main object of detecting presence of users taking a resource into use.

According to the invention, the control device is configured to detect presence of a user of a resource that the control device is arranged to monitor usage for. When detecting presence of a user of the associated resource, presence data relating to the detected presence of the user is communicated to the scheduling server, the presence data indicating that a reservation of the resource is taken into use.

In this way, the system, e.g. the control device, may detect, e.g. automatically, presence of a user, e.g. when entering a room and passing e.g. a display device or other kind of control device, where this detection may be used as a confirmation that a scheduled reservation of a resource is taken into use. When communicating this to the scheduling server, the scheduling server may be configured to maintain the reservation, the resource thereby continuing to have the status occupied in the scheduling system, and in the case of a display device this status may also be displayed. On the other hand, if no confirmation of a reservation being taken into use is received by the scheduling server, e.g. within a predetermined period of time from the start time of the reservation, the reservation may be arranged to be cancelled and hence the remaining portion of the reserved time slot may be made available for use by others. The scheduling server may be arranged to cancel a reservation if no indication regarding the resource being taken into use is received from the control device within a predetermined period of time. Alternatively, the scheduling server may be arranged to cancel a reservation only if the control device communicates to the scheduling server that the resource has not been taken into use.

According to embodiments of the invention, the user is prompted regarding the reservation prior to cancellation, so that the user may confirm presence e.g. in case the user was not properly detected when taking the resource into use to thereby avoid situations where otherwise the reservation may be cancelled.

The scheduling system may control reservations of a plurality of resources, and each resource may be associated with a control device. Different resources may be associated with different control devices.

The automatic detection of a user may be carried out in various ways. According to embodiments of the invention, short-range communication, such as short-range light (e.g. infrared) or radio communication is utilised between control device and user a device, where the control device detects presence of a user device of a user coming in the vicinity of the control device using the short-range communication. The short-range may e.g. be a distance between user device and control device at most being 1 meter, 5 meters or 10 meters. When the user device is detected, the control device may communicate this to the scheduling server according to the above. With regard to the short-range radio communication, any suitable communication protocol may be utilised, such as e.g. Bluetooth or NFC or any other short-range protocol suitable for determining presence of a user device at such short distance from the control device that it can be considered that the user device is taking the scheduled resource into use, and not any other resource e.g. being co-located with the resource in question. Wi-Fi transmissions from the user device may also be utilised, and it is also contemplated that the user device e.g. automatically registers with a local Wi-Fi network or other type of network controlled by the control device to thereby be detected.

The control device may be configured to detect signals transmitted by the user device without any user interaction being required, e.g. by the user device either attempts to communicate with the control device using e.g. an application, but user devices in general transmit e.g. Bluetooth, Wi-Fi, or other wireless technology signals that may be utilised by the control device in the automatic detection of the user device without user interaction. Consequently, according to embodiments, it is sufficient that the device is detected, without actual communication between user device and control device.

According to embodiments of the invention, it is sufficient that any user device of any user is detected to determine that a reservation is taken into use.

However, according to embodiments of the invention, it is required that a user device of any user being associated with the current reservation is detected, such as any participant of the scheduled event. According to embodiments of the invention it is required that the person/user being responsible for the reservation is also deemed to be present at the resource in order to determine that the resource has been taken into use.

The control device may comprise communication means for communication with the scheduling server by means of any suitable communication protocol using any suitable communication link.

The use of display devices as control devices allows scheduling changes of a resource, such as a cancellation of a reservation, to be immediately be reflected by the display device that is used to display reservations of the resource. Consequently, the use of display devices has, among other, the advantage that a person looking for an available resource can see the newly added resource availability on the display device.

As was mentioned, any suitable device associated with a resource may form control device according to the invention. For example, a dedicated device situated in proximity to, e.g. within, a resource. Automaticdetection of a presence of a user may also be performed in any suitable manner, and e.g. comprise the control device detecting use of one or more systems present at the resource. With regard to a meeting room, for example, the control device may be arranged to detect start-up or use of e.g. a video conferencing system and/or other equipment, and when such use is detected, it can be determined that a reservation of the resource has been taken into use and this can be communicated to the scheduling server.

Such embodiments may, or may not, provide information in terms of whether the current user is actually the person that made the reservation, but may still provide information regarding whether the resource is taken into use. Furthermore, e.g. video conferencing systems may be used to detect presence, e.g. using motion sensors, and communicate this to the control device, or include itself the functionality of the control device and hence communicate status to the scheduling server. If a login procedure is utilised by the entity acting as control device, an identity of the user may be obtained in this manner.

Also, if it is detected that a device belonging to the user registers with e.g. a wireless network of the resource, this may be used as detection of the user.

According to embodiments of the invention, it is also determined if a remaining period of time a reservation of a resource is to be cancelled prior to the scheduled ending time. Use of resources may end prior to the scheduled ending time of a reservation, with the possible result that resources may appear occupied while being available. Cancelling the remaining portion of a reservation when use of a reservation is ended may increase resource availability in the system. The determination of whether the reservation is to be cancelled prior to the scheduled ending time may be determined in various manners, e.g. by short-range communication in a manner similar to the above, e.g. by the control device determining that the use of a reservation based on signalling from a user device.

If the user device comprises an application pertaining to the scheduling system, the user may be prompted via the application to confirm that the meeting is to end with a request for confirmation regarding this matter. This may be communicated e.g. if the user device is again detected following a period of time when it has not been detected, which may e.g. be the case if the control device does not cover the spatial extension of the resource which may extend beyond the short-range communication coverage area of the display device. Alternatively, or in addition, if the user device is continuously detected during a reservation of a resource but is no longer detected, e.g. at least for a period of time, such as some suitable number of minutes, the user may also be prompted regarding possible cancellation of the remaining portion of the reservation. In case a user device application is used, communication may also be arranged to be accomplished e.g. using the network by means of which the control device communicates with the scheduling server. In this way, the user may be prompted also when the user device no longer is within range of short length communication with the control device. The user may also be notified e.g. using a conventional mobile network messaging service.

According to embodiments of the invention, the system may be utilised to perform analysis of resource usage. For example, the detection of resources that actually has been taken into use may be utilised to evaluate actual use of resources in relation to made reservations. In this way, e.g. an actual degree of utilisation of a particular resource, or the resources as a hole, may be evaluated.

According to embodiments of the invention, the system may not have previous knowledge of the identity/identifier of a user device, but may learn such identification data by collecting user device identities/identifiers used in the determining of whether a resource is taken into use. These identifiers may be correlated with reservation data, and e.g. from multiple reservations by a user, and/or multiple occurrences of presence of a particular user device identifier an identity of a user device may be determined by the system itself. In this way, resource usage and user behaviour may be determined on a user level. For example, the identifiers may comprise e.g. digital signatures of user devices, such as laptops, tablets, phones etc. The identifiers in combination with reservation data may then be utilised to associate the identifiers with users. The control device may communicate user device identifying data to a system node, e.g. scheduling server or another server, which may correlate user device data with scheduling data e.g. for a plurality of reservations and/or resources. This data may then be used to correlate a particular device with a particular user.

Consequently, irrespective of whether the identity of a user device and hence user is stored beforehand or determined through the use of collected data according to the above, user behaviour can be analysed. For example, it can be evaluated whether users making reservations tend to actually make use of the reservations, or whether users tend to make reservations but in reality not always make use of them. It may also be determined whether a user tends to make reservations for longer periods of times than in reality is utilised by the user.

Hence, in particular use of data from personal user devices of users may render possible substantial knowledge of user behaviour of users utilising resources of the scheduling system. Perhaps in particular when user devices “checks-in” automatically with the control device when they arrive and “check-out” automatically as they leave.

In addition, according to embodiments of the invention, it is made possible to obtain a detailed understanding of the manner in which a particular resource is used e.g., in relation to capacity in number of participants, equipment and location. If the data is combined with knowledge of e.g. facilities such as equipment of a resource, the system may, on the basis of resource utilisation, output possible improvements in room utilization, equipment changes that may increase utilisation of a particular resource and also determine a most usable size of resources.

According to embodiments of the invention, the system, e.g. using collected actual usage data, may predict which resources are most frequently reserved, and at which points in time such resources are utilised the most. The system may then prompt a user having made a reservation to confirm that the reservation is to remain prior to the reservation starts and e.g. 24 hours or more before the reservation starts, so that e.g. highly utilised resources may be made available for other users to reserve.

Further characteristics of the present invention, and advantages thereof, will be evident from the following detailed description of preferred embodiments and appended drawings, which are given by way of example only, and are not to be construed as limiting in any way.

### BRIEF DESCRIPTION OF THE DRAWINGS

FIG. 1 schematically shows resources for which dedicated display devices are being utilized for displaying scheduling information in an information display system.

FIG. 2 schematically shows a network architecture of an information display system and scheduling system.

FIG. 3 schematically shows a display of display device according to embodiments of the invention.

FIG. 4 shows an exemplary method according to embodiments of the invention.

FIG. 5 schematically shows a hardware architecture of a control device according to embodiments of the invention.

### DETAILED DESCRIPTION OF AN EXEMPLARY EMBODIMENT

In the following description and claims, the term “scheduling server” is used to represent any server that is responsible for and handling reservations with regard to at least one but preferably a plurality of resources.

Furthermore, the term “resource” is used to represent a physical resource that can be reserved for use by a user. Examples of such resources are, in a non-limiting manner, meeting (conference) rooms, parking lots, class rooms (with regard to, e.g. schools), operating rooms (with regard to hospitals), office space, exhibition rooms and so on and so forth.

Efficient scheduling and use of resources of the exemplified kinds can be facilitated by arranging a control device such as a display device associated with a resource e.g. in the proximity of the location of the resource, such as at the entrance of or within, a meeting room. A control device may be associated with a single resource, or be associated with a plurality of resources. Also, each of a plurality of resources may each be associated with an individual control device. That is, each of a plurality of control devices may be only associated with a single resource.

The control devices may be used to display relevant information outside e.g. an associated meeting room, i.e. consist of display devices, where the information may include information regarding a scheduled meeting, and where the display devices may automatically synchronize with a scheduling system so as to ensure that updated data is always presented on the display device.

FIG. 1 shows an example of a meeting room area 100 in which the present invention can be utilized. The meeting room area comprises three meeting rooms 101, 102,103, each being provided with an associated control device in the form of a display device 104,105,106. The display devices 104-106 are used to display reservations (bookings) of the associated meeting rooms 101-103, respectively.

The display devices 104-106 are arranged to display selected meeting information outside the meeting rooms 101-103, thereby assisting participants of a meeting to properly locate the particular meeting room in which the meeting is to be held. Apart from displaying information in regard of already made reservations, the display devices may also be provided with an indicator, such as, e.g. lights (for example, red for occupied and green for unreserved) to avoid interruption of ongoing meetings, or for finding a meeting room that is free for reservation and even allow visual determination of room availability from a distance.

For example, a part of the frame of the display device may comprise a LED (or other kind of light source) indicator indicating the status of the room so that the status can be determined by a user from relatively long distance.

FIG. 3 illustrates an exemplary display device 104, which may be used as any or all of the display devices 104-106 of FIG. 1, and that may be utilized according to embodiments of the present invention. The display device 104, which hence is associated with meeting room 101 of FIG. 1, is seen from the front and essentially the full face of the display device consists of a screen 301 for displaying information. A circumferential portion 302 of the display device 104 is, according to embodiments of the invention, configured to be illuminated, e.g. using LED or other suitable light-emitting technology, where the emitted light may be arranged to change colour in dependence of scheduling status, e.g. between green and red, where green may indicate that the resource current is unscheduled and free for use, while a red colour may be used indicate that the resource is currently scheduled and hence not free for use.

In addition, the circumferential portion 302 may be configured to emit also at least a third colour, such as e.g. orange. For example, this may be utilised to indicate that the start time of a reservation has commenced, but presence of a user taking the reservation into use has not yet been confirmed. In this way, e.g. someone looking for a resource to use may check whether anyone actually shows up to take the resource into use, and if no one appears the resource may be taken into use by the person looking for a unoccupied resource. This may be performed either by using the ongoing reservation or by making a new reservation in case the original reservation is cancelled by the system.

The further, e.g. orange, colour may also be used to notify a user of the fact that the system has not detected presence of a user, and hence not detected that a reservation has been taken into use, e.g. in case the user device has not been detected by the control device. In this way the user may e.g. manually notify the system of a presence, e.g. by pressing a button or in any other suitable manner, to avoid that the reservation is unintentionally cancelled, with the risk that somebody else makes a reservation of the resource for a period of time that the current user still is in believe of having reserved. This functionality may be utilised also in situations where it is always required that the user actively confirms presence when taking a reservation into use. The indication may also be arranged to be visible e.g. from inside a meeting room to alert a user of an already started meeting.

The display device 104 may also be configured to emit light both in a forward and a backward direction, and hence not only in a direction outward from e.g. from a wall upon which the display device 104 is mounted, but also e.g. towards the wall to thereby enhance the visual effect of the occupied/free for use status of the resource associated with the display device 104 using reflections on the wall.

FIG. 3 further illustrates an exemplary layout of data being displayed by the display device 300 when in use. The display of the display device can be of any suitable kind, e.g. a Liquid Crystal Display or a LED display, and according to the disclosed example, the current time is indicated by a digital representation of an analogue clock 303 being encircled by a circle 304 which, in turn, represents the dial of the clock and which indicates scheduled events 304a, 304b, 304c, 304d, e.g. by illuminating or otherwise indicating the portions of the dial that represents the extension in time of the scheduled events. For example, a red colour may be utilised for scheduled portions of the dial. Similarly, unscheduled, and hence free for use, portions of the dial may be lit green. In this way, a user being present at the display device 300 may receive highly informative information regarding possible times of the day where the associated resource may be reserved, and also participants of a current reservation may see when a next event is scheduled to commence, so that possibilities to extend the endpoint of a current reservation can be easily determined if needed. The exemplified display area also comprises a field 305 comprising information regarding the current reservation. According to the disclosed example, the room is available pending an upcoming reservation. The display area further comprises a field 306 presenting information regarding the next scheduled event, where this information e.g. may include one or more from: start and end times of the scheduled event, person/entity responsible for the reservation, title of the event, participants of the event, etc. The display also comprises a field 307 identifying an identity of the associated resource, such as “Meeting room 101”.

The particular display layout of the display device 104 is only exemplary, and various different layouts may be utilised. Depending on the layout, display devices of the exemplified kind may, e.g., be arranged to display reservations for a defined period of time, such as, e.g. the next couple of hours, a full day, all days of the week, etc., and as exemplified also be arranged to display further data such as the name/identity of the person responsible for the reservation, and/or participants and/or subject of the meeting. Display devices of the disclosed kind may also provide further functionality and may e.g. allow reservation of an available resource or extend and/or delete an existing reservation when the meeting schedule is changed, e.g. by touching appropriate portions of the dial according to the present example. The displayed data may also be arranged to change e.g. if the display is being touched to thereby provide further alternatives for the user to make/change/delete reservations. Display devices of the disclosed kind may also be arranged to allow reservations of other resources than the resource(s) that the particular display device is associated with.

FIG. 2 shows an exemplary layout of the system of FIG. 1. The display devices 101-103 are connected to a computer network 201, which can be a computer network of any suitable wired or wireless kind. FIG. 2 further discloses user computers 202-204, by means of which users of the scheduling system may check availability of resources of the system, such as meeting rooms 101-103, and make reservations, update reservations or delete an existing reservation. The reservations may be performed e.g. using any conventional calendar system. Consequently, a user of the system performs a resource reservation, such as a meeting room reservation, in any conventional or any other suitable manner.

The display devices of the information display system are connected to a scheduling server 205, which administers reservations of a plurality of resources. The display devices 101-103 may provide an additional interface that facilitates overview of existing reservations, so that reservations are not only visible via user computers, but also e.g. at the actual location of the resource. FIG. 2 also shows user terminals 210, 211, 212, of users of the scheduling system and which may be utilised to determine presence of a user at a resource as discussed below. According to embodiments of the invention, the user devices 210-212 may also be used to communicate with the scheduling server 205 e.g. to make or delete reservations. In addition to short-range communication, the control device may be arranged to communicate with the user devices 210-212 also via the communication network 201.

As was mentioned above, use of scheduling systems may facilitate resource usage e.g. in that a user of the system need only consult e.g. a computer to determine whether there is a resource available at a desired point in time. In addition, user of display devices may further facilitate determination of room availability when a user is present at a resource. If a plurality of resources are co-located, a user may in a relatively simple manner essentially simultaneously determine availability of a plurality of resources.

However, as was also mentioned, the efficiency of scheduling systems, and in particular resource usage, may be impaired by less than optimal user behaviour. For example, users may make reservations for resources, without subsequently actually make use of the reservations/resources. Thereby reserved resources may in reality not be in use, but still when other users search for resource availability, such resources may appear occupied and thereby cause other users to look elsewhere.

Also, a reservation may be made for a period of time, such as e.g. one hour or more, but where actual use of the scheduled resource may take place during only a portion of the reserved period of time. For example, e.g. a meeting may end prior to the reserved reservation time ends. Hence resources may appear occupied while in reality being available for use for this reason also.

It has been realized that system performance could be further enhanced by automatically controlling actual utilisation of resources such as meeting rooms.

According to embodiments of the invention, this is accomplished through the use of a control device arranged in, or in proximity to, the resource that the control device is associated with. As mentioned, the control device may consist of a display device of the disclosed kind but may also comprise any other suitable device arranged in or in proximity to the associated resource. That is, the control device may essentially consists of any suitable device that may be configured to detect the presence of a user of a scheduled resource and communicate this to the scheduling server.

An exemplary method 400 according to embodiments of the invention is disclosed in FIG. 4 and discussed in the following. The exemplary method 400 starts in step 401, where it is determined whether there is a reservation of the resource for which presence is being evaluated. The method may be performed concurrently for a plurality of resources at a time, or for a single resource at a time. Furthermore, a person skilled in the art will appreciate that a method for controlling utilisation of a resource according to embodiments of present invention may be implemented in a computer program, which, when it is executed in a computer, instructs the computer to execute the method. The computer program may be constituted by a computer program product stored on a non-transitory/non-volatile digital storage medium, in which the computer program is incorporated in the computer-readable medium of the computer program product. The computer-readable medium comprises a suitable memory, such as, for example: ROM (Read-Only Memory), PROM (Programmable Read-Only Memory), EPROM (Erasable PROM), Flash memory, EEPROM (Electrically Erasable PROM), a hard disk unit, etc., and be arranged in or in connection with the control device or scheduling server or at any other suitable location. Also, the method may be implemented part in the control device and part in the scheduling server.

The method may remain in step 401 for as long as there is not an active reservation, that is, even if there are reservations for a future or past period of time, the resource is unscheduled at the present point in time. If, however, the current time has past the start time of a reservation, the method continues to step 402. The transition from step 401 to step 402 may also be arranged to occur e.g. a predetermined period of time before a scheduled event is to begin, e.g. to account for participants arriving early. In step 402 it is determined whether presence of a user of the resource has been detected. According to embodiments of the invention, this is determined using the control device, in the present example the display device 104. This is accomplished using short-range radio communication between a fixed hardware device, in the present example the display device, and a personal device, e.g. a user device such as user device 210-212.

Part of the hardware of the display device 104 is schematically illustrated in FIG. 5, and comprises a network interface 501 for allowing connection to the computer network 201 in order to communicate with the scheduling server 205. The network interface 501 may be an interface for wired and/or wireless communication over the computer network 201. The display device 104 further includes a central processing unit 502 such as a Microprocessor or Micro controller for controlling the operation of the display device. The central processing unit 502 communicates with entities on the computer network 201 via the network interface 501, such as scheduling server 205 and possible further entities and possibly also user devices. The central processing unit 502 further controls data to be displayed on the display of the device 104, e.g. via a video display adapter 503, where data may be displayed e.g. as exemplified with reference to FIG. 3. Operation of the display device 104 may, e.g. be controlled by software stored in a memory 504 connected to the central processing unit 502.

According to embodiments of the invention, the detection of presence of a user in step 402 of FIG. 4 is detected by detecting presence of a user device 210-212 belonging to a user. According to embodiments of the invention, this may be any user, and according to embodiments of the invention this may be a user associated with the reservation, such as a participant of the reservation, e.g. stated as a participant of e.g. a meeting in the reservation, which data may be communicated from scheduling server to control device. According to embodiments of the invention it is required that it is a user responsible for the reservation. The user responsible for the reservation may be the user that actually made the reservation, or a user on behalf of which the reservation was made by another person.

The detection of presence of a user may be accomplished automatically by the display device 104 using e.g. suitable short length radio communication or other radio communication means 506 the display device 104 and the user device. For example, Bluetooth, Wi-Fi, NFC (Near Field Communication), or any other suitable wireless protocol may be utilized as is appreciated by the person skilled in the art.

For example, the display device 104 may be configured to detect Bluetooth signalling, or other signalling, from a user device entering the resource/meeting room. The signalling may e.g. be signalling that in general is activated on the user device, or that is being automatically activated as the user devices comes within the vicinity of the resource so that no user action is required when the control device detects presence of the user.

According to embodiments of the invention, the display device 104 is arranged to passively detect communication signals of a user device. That is, the display device 104 may read signals transmitted by the user device 210-212 without any actual communication occurring between display device and user device. The display device 104 may, however, e.g. also be provided with means for establishing a communication with the user device 104, so that, e.g. using an application in the user device, which may form part of and/or be designed for, the scheduling system, a message may be displayed on a screen of a user device, where the user e.g. may be prompted to confirm that the reserved resource is taken into use, and when a confirmation is received the display device may transmit a confirmation to the scheduling server. Alternatively, the user may be prompted to reject that the reserved resource is taken into use, and if no rejection is received the reservation will automatically be considered as taken into use. The prompting may be transmitted by the display device over the short-length communication protocol, or e.g. via computer network 201 if the user device is connected to this. Alternatively e.g via a mobile network. The display device may also request the scheduling server to perform and control the prompting of the user/user device. The user device may also be informed that the resource now has been taken into use.

According to embodiments of the invention, the display device 104 may be arranged to collect and/or store e.g. Bluetooth signatures, and/or signatures of other wireless protocols, of user devices, where this data can be stored e.g. centrally in the system such as in the scheduling server or in any other suitable entity in the system, such as e.g. a further server/computer.

The control device may, upon detection of a signature/radio signal relating to a user device, transmit this information to such other system node, which e.g. may be configured to receive user device data from all control devices in the system.

In this way, a database of signatures of user devices may be established, where the system may learn identities of particular users e.g. by associating signatures/identifiers of user devices with users making reservations and/or forming part of meetings.

For example, if a particular user device is always present when a particular user has made the reservation, the user device can be associated with the user, and as time progress a database comprising users and associated user devices can be established. This, in turn, will facilitate automatic recognition of users taking a reserved resource into use.

Automatic detection of whether a reserved resource has been taken into use may also be utilised to determine actual resource usage. For example, according to embodiments of the invention, data may also be collected in regard of whether a reserved resource has actually been taken into use. This data may be used to generate statistics over actual resource usage versus made reservations, so that actions can be taken if necessary e.g. in order to motivate users to cancel reservations at an earlier stage in case the reservations is not to be made use of. Usage data of this kind may be arranged to be collected, irrespective of whether the user is automatically detected, or instead is required to explicitly notify the control device of the presence.

According to embodiments of the invention, it is sufficient that the resource is taken into use by any person. However, according to embodiments of the invention, it is required that the person responsible for a reservation is determined as being present in order to determine that the resource has been taken into use.

When the display device detects 104 presence of a user, such as a user associated with the reservation, the method continues to step 403, where the display device 104 transmits a notification to the scheduling server, where the notification indicates that the scheduled resource has been taken into use. The signature of the detected user device may also be transmitted, e.g. to the scheduling server or a further entity, where e.g. the further entity, such as a server or computer may be responsible for collecting the identifiers and/or for performing analysis of the scheduling system, such as exemplified below.

If, on the other hand, it is determined in step 402 that the display device 104 has not received an indication of the presence of a user associated with the reservation of the resource, the method continues to step 404 where it is determined if a predetermined period of time has lapsed since the start time of the reservation. This predetermined period of time may be set to any suitable time and e.g. equal some suitable number of minutes, such as e.g. 15 or 20 or 30 minutes. If the predetermined period of time has not yet elapsed the method returns to step 402 to again determine if a user associated with the reservation has arrived to take the resource into use. If the predetermined period of time as lapsed, and hence the resource still has not been taken into use, the method continues to step 405 where this is communicated to the scheduling server 205, so that in step 406 the reservation can be cancelled by the scheduling server and the resource thereby be made available for use by other users, which may also be indicated e.g. on the display of the display device. The method is then ended in step 409.

According to embodiments of the invention, prior to a reservation being actually cancelled, a user device of the user having made the reservation may be prompted to allow the user to maintain the reservation in case this in reality is actually being utilised or is about to be utilised. According to the invention, consequently, the use, and non-use, of reservations of scheduled resources can be automatically determined so that resources may be utilised in a more efficient manner.

When it has been determined in step 402 that the resource is taken into use and the scheduling server has been notified accordingly in step 403, the method may, according to embodiments of the invention, be ended, i.e. the ongoing reservation, once determined to have been taken into use, may be considered to have an extension in time corresponding to the scheduled length of the event.

According to embodiments of the invention, however, the method may continue to a step 407, where it may be determined if the resource is still in use or whether a remaining period of time of a reservation of a resource is to be cancelled prior to the scheduled ending time. As was mentioned above, e.g. meetings oftentimes end prior to the scheduled ending time, with the possible result that availability of resources may be undesirably reduced. The determination of whether the reservation is to be cancelled prior to the scheduled ending time may be determined in various manners, e.g. by short-range communication in a manner similar to the above.

For example, if the user device comprises an application pertaining to the scheduling system, the user may be prompted via the application to confirm that the meeting has ended with a request for confirmation. This may be done e.g. if the user device is again detected following a period of time where it has not been detected, which e.g. may be the case if the meeting room extends beyond the coverage of the display device but the user device comes within range of the display device when exiting the meeting room. Alternatively, or in addition, if the user device is continuously detected during e.g. a meeting but is no longer detected e.g. for a period of time, such as some suitable number of minutes, the user may also be prompted since this may indicate that the user may have left the meeting room. The communication between the application and the display device may e.g. be arranged to take place over the communication network 201, e.g. via the scheduling server, so that communication may occur also when the user device is out of range for short-range radio communication with the display device.

If the user is prompted for confirmation regarding cancellation of the remaining time of a reservation, the user may also e.g. be given alternatives such as e.g. taking a break for x minutes etc.

If it is determined that a remaining portion of a reservation is to be cancelled, this is signalled to the scheduling server in step 408 and the method is then ended in step 409.

According to embodiments of the invention, e.g. when the resource is a room or other physical location, further means may be arranged e.g. in the room and arranged to indicate the reservation status. For example, the colour of a light may be controlled by the display device to provide an indication also from within the room. Also, the display device may e.g. be arranged to communicate with a video conferencing system or other system present at the resource, e.g. over computer network 201, so that status of the resource e.g. may also be displayed on a display of e.g. a video conferencing system.

According to embodiments of the invention, the control device is, instead, any suitable device co-located with the resource, such as a control device located at the interior of a meeting room. This device may be a multi-purpose device and e.g. be responsible for other functionality of, or present in/at, the resource. For example, the control device may form part of e.g. a video conferencing system. The control device may also be a dedicated device being specifically configured to detect presence of a user, and to communicate this presence to the scheduling server. In principle, any suitable device associated with a resource may form control device according to the invention. According to embodiments of the invention, the detection of a presence of a user is not performed using short-range communication between control device and user device, but may also be performed in any suitable manner, and e.g. comprise the control device detecting use of one or more systems present at the resource. With regard to a meeting room, for example, the control device may be arranged to detect start-up or use of e.g. a video conferencing system and/or other equipment, and when such use is detected, it can be determined that a reservation of the resource has been taken into use and this can be communicated to the scheduling server.

Such embodiments may provide less resolution in terms of whether the current user is actually the person that made the reservation, but may still provide information regarding whether the resource is taken into use. Furthermore, e.g. video conferencing systems may be used to detect presence, e.g. using motion sensors, and communicate this to the control device, or include itself the functionality of the control device and hence communicate status to the scheduling server.

As has been mentioned, according to embodiments of the invention, the system may be utilised to perform analysis of resource usage. For example, the detection of use can be utilised to evaluate actual use in relation to made reservations. In this way, e.g. an actual degree of utilisation of the scheduling system may be evaluated.

If the system is arranged to detect presence of a user device, further analysis may be performed. According to embodiments of the invention, the system may not have previous knowledge of the identity of e.g. user devices 210-212, and hence not about the users of the user devices, but may learn such identification data by collecting user device identities used in determining whether a resource is taken into use. If, for example, user of user device 210 performs a number of reservations, and an identifier of user device 210 is then found present at these reservations, it may be concluded that identifier of user device 210 may be associated with a particular user of the scheduling system. Hence, the system may learn to identify users. However, according to embodiments of the invention, identifiers may be stored in the system for various user devices, and associations with users, for use when determining whether a resource has been taken into use.

Furthermore, when a user device is used to determine presence of a user, irrespective of whether the identity is stored beforehand or determined using collected data according to the above, user behaviour can be analysed. For example, it can be evaluated whether users that make reservations tend to actually make use of the reservations, or whether users tend to make reservations but in reality never take the resource into use.

Furthermore, according to embodiments of the invention, usage of the resource may be analysed, and it may be determined e.g. one resource is preferred in relation to another. For example, it may be determined whether e.g. room size, location or room equipment may influence the reservation.

Also, as was mentioned, the system may be configured to predict which resources that are most frequently reserved, and may then prompt a user having made a reservation to confirm that the reservation is to remain prior to the reservation starts so that e.g. highly utilised resources may be made available for other users to reserve. For example, the user may be prompted e.g. 24 hours or more before the reservation starts, or a time determined based on when the reservation was made. For example, if the reservation was made a longer time ago, the user may be prompted earlier than when a reservation was made closer to the actual time of utilisation of the resource.

The present invention is not limited to the above described embodiments. Instead, the present invention relates to, and encompasses all different embodiments being included within the scope of the independent claims.

1. A system for scheduling resources,
the system comprising:
a scheduling server for controlling reservations by users of a plurality of resources;
a control device configured to, when associated with a resource, communicate data regarding the associated resource to the scheduling server;
characterised in:
the control device being configured to detect presence of a user of an associated resource; and
when detecting presence of a user of the associated resource, communicating presence data relating to the detected presence of the user to the scheduling server, the presence data indicating that a reservation of the resource is made use of.

2. A system according to claim 1, characterized in that:
the control device is a display device configured to, in use, display scheduling information relating to the associated resource, the display device being configured to, in use, receive the scheduling information to be displayed from the scheduling server.

3. A system according to claim 1, characterized in that:
the control device being configured to, in use, be located in proximity to the associated resource to determine presence of a user.

4. A system according to claim 1, characterized in that:
the control device being configured to detect presence of a user by detecting presence of a user device of the user through short-range signalling, such as short-range radio communication.

5. A system according to claim 1, characterized in that:
the control device being configured to, when detecting presence of a user device of a user, initiate transmission of a message to the user device, the message requesting the user to communicate use and/or non-use of the resource during the reserved period of time.

6. A system according to claim 1, characterized in that:
the control device being configured to detect presence of an identifier of a user device associated with a user associated with a reservation of the resource, and
the control device being configured to communicate presence data indicating that the resource is taken into use to the scheduling server when detecting presence of said identifier identifying a user associated with the reservation.

7. A system according to claim 1, characterized in that:
the control device being configured to, when a predetermined period of time after a reservation is scheduled to commence has lapsed, when presence of a user has not been detected within said predetermined period of time, communicate to the scheduling server an indication that the reservation is to be cancelled.

8. A system according to claim 1, characterised in that:
the scheduling server being configured to, when an indication that a resource has been taken into use is not received from the control device within a predetermined period of time from the start time of a reservation, cancel the reservation.

9. A system according to claim 1, characterised in that:
the control device being configured to, when a resource has been taken into use, determine presence of a user of an associated resource;
based on the determined presence, determine whether a remaining period of time of the reservation is to be cancelled; and
when it determined that the remaining period of time of the reservation is to be cancelled, communicate to the scheduling server an indication that the remaining time of the reservation is to be cancelled.

10. A system according to claim 1, characterised in that:
the control device is configured to detect presence of a user responsible for a reservation of an associated resource; and
communicating to the scheduling server that a reservation of the resource is made use of only if detecting presence of a user responsible for a reservation of an associated resource.

11. A system according to claim 1, characterized in that:
the system includes means configured to correlate identifiers identifying user devices, the identifiers being received by control devices using short-range signalling, with data regarding representations of users associated with reservations so as to correlate identities of user device with users of the scheduling system.

12. A system according to claim 1, characterised in that:
the system includes means for, prior to a reservation of a resource commences, prompting user responsible of the reservation to indicate whether the reservation is to be maintained.

13. A system according to claim 1, characterised in that:
the system being configured to, when detectable signals are transmitted by a user device, automatically detect presence of a user device without user interaction by detecting the detectable signals transmitted by the user device,
the system being further configured to communicate the detected presence to the scheduling server, the detected presence data indicating to the scheduling server that a reservation of the resource is made use of.

14. A system according to claim 1, characterised in that, when a user device is detected by detectable signals being received by the control device from a user device:
associating the user device with a user associated with the reservation of the resource.

15. A system according to claim 14, characterised in that:
the control device is configured to transmit signals identifying the user device to a server, the server associating a user device to a first user following reception of detections of the user device for a plurality of reservations made by said first user.

16. A system according to claim 15, said server being configured to receive detections of user devices from a plurality of control devices associated with different resources.

17. A control device for s system for scheduling resources,
the system comprising:
a scheduling server for controlling reservations by users of a plurality of resources;
a control device configured to, when associated with a resource, communicate data regarding the associated resource to the scheduling server;
characterised in:
the control device being configured to detect presence of a user of an associated resource; and
when detecting presence of a user of the associated resource, communicating presence data relating to the detected presence of the user to the scheduling server, the presence data indicating that a reservation of the resource is made use of.

18. A method for a scheduling system,
the system comprising:
a scheduling server for controlling reservations by users of a plurality of resources;
a control device configured to, when associated with a resource, communicate data regarding the associated resource to the scheduling server;
the method comprising:
by means of a control device detecting presence of a user of an associated resource; and
when detecting presence of a user of the associated resource, communicating presence data relating to the detected presence of the user to the scheduling server, the presence data indicating that a reservation of the resource is made use of.

19. Computer program product, characterised in code means included in a computer readable medium, which when run in a processing unit of a computer causes the control unit to execute the method according to claim 18.
